(19) United States
(12) Patent Application Publication
(10) Pub. No.: US 2023/0157414 A1
(43) Pub. Date: May 25, 2023

(54) BOOTS WITH GUSSET

(71) Applicant: Tingley Rubber Corporation, Piscataway, NJ (US)

(72) Inventors: James P. Towey, Nutley, NJ (US); Steven A. Smith, Pompton Plains, NJ (US); Robert N. Petersen, Somerset, NJ (US)

(73) Assignee: Tingley Rubber Corporation, Piscataway, NJ (US)

(21) Appl. No.: 18/100,336

(22) Filed: Jan. 23, 2023

Related U.S. Application Data
(62) Division of application No. 15/879,983, filed on Jan. 25, 2018, now abandoned.
(60) Provisional application No. 62/450,838, filed on Jan. 26, 2017.

(51) Int. Cl. A43B 23/04

(52) U.S. Cl. CPC A43B 23/047; A43B 3/04

(57) ABSTRACT

A boot comprises: an outsole and a polymeric upper affixed to the outsole. The upper comprises an upper body and a gusset, which comprises a relaxed position and an expanded position, wherein the gusset moves from the relaxed position to the expanded position to accommodate a wearer's leg upon donning of the boot.

### CROSS-REFERENCE TO RELATED APPLICATIONS

This application is a Divisional Application of U.S. patent application Ser. No. 15/879,983, filed Jan. 25, 2018, which claims priority under 35 U.S.C. § 119(e) to U.S. Provisional Application No. 62/450,838, filed Jan. 26, 2017, the disclosures of which are incorporated herein by reference in their entireties.

### TECHNICAL FIELD

The present disclosure generally relates to boots having a gusset that comprises a relaxed position and an expanded position. The gusset moves from the relaxed position to the expanded position to accommodate a wearer's leg upon donning of the boot.

### BACKGROUND

Liquid protection boots are designed to protect feet and lower leg portions against infusion of liquid during wet conditions. Polymeric materials are suitable for forming liquid protection boots, which makes them amenable to injection molding techniques. Creation and design of molds for boots can become complex and costly due to a wide range of wearer sizes and comfort and functional preferences. Foot size and shape can vary, but so does the size, shape and circumference of possible wearers. For some boots, adding features for comfort and function can require additional manufacturing steps and materials beyond initial injection molding. For example, some prior art boots utilize stretchable elastic fabrics as gussets, which require additional manufacturing steps and materials beyond the formation of the underlying boot. Some prior art boots include gussets in combination with fasteners, where the fasteners are needed to close-up a gusset during wearing of the boot.

There is an on-going need to manufacture boots efficiently by injection molding. There is also an on-going need to provide boots that are comfortable while providing liquid protection. There is a need to provide boots that can accommodate varying sizes of legs.

### SUMMARY

Provided are boots with enhanced features. The boots herein have gussets that accommodate a wearer's leg upon donning of the boot.

In an aspect, a boot comprises: an outsole; and an upper affixed to the outsole, the upper comprising a polymeric upper body and a polymeric gusset comprising a relaxed position and an expanded position, wherein the gusset moves from the relaxed position to the expanded position to accommodate a wearer's leg upon donning of the boot.

In a detailed aspect, a liquid protection knee boot comprises: an outsole of a first polymeric material; and an upper of a second polymeric material. The upper is affixed to the outsole and comprises an upper body, a topline opening defined by an edge of the upper body, and a gusset intersecting the edge of the upper body. The gusset is effective to expand the edge from a relaxed position to an expanded position to accommodate a wearer's leg upon donning of the boot.

A further aspect is a method of making a boot comprising: forming an outsole by injecting a first polymeric material into a first mold cavity; forming a gusset by injection molding a second polymeric material; forming an upper body by injecting a third polymeric material into a second mold cavity; forming an upper comprising the gusset and the upper body; and affixing the upper to the outsole.

Another aspect provides a method of providing comfortable boots to wearers, the method comprising: donning any boot disclosed herein; and expanding the gusset as needed to accommodate the wearer's leg.

### BRIEF DESCRIPTION OF THE DRAWINGS

FIG. 1 is a schematic side view of a boot;

FIG. 2 is a schematic rear view of a boot;

FIG. 3 is a schematic top view of a boot; and

FIGS. 4A and 4B provide close-up schematic views of the gusset located on a rear side of the boot; and

FIG. 5 is a schematic bottom view of an outsole.

### DETAILED DESCRIPTION

Boots disclosed herein have an advantage in that a polymeric gusset accommodates a wide variety of calf and leg sizes. The gussets herein have a relaxed, unexpanded position that expands as needed to accommodate a wearer's leg upon donning of the boot. An integrally-formed polymeric gusset eliminates the need to provide additional processing steps to insert or separately affix a gusset of a separate material and associated fastener. A calf-relief gusset (with “accordion fold” construction) expands a circumference of an edge or a topline opening defined by the edge of a boot. The edge or topline opening may expand by a minimum of one inch versus a conventional smooth opening boot upper. In one or more embodiments, the circumference of the edge may increase from about 3 to about 10%, preferably in a range of 4-6%. The expandable calf-relief gusset allows a comfortable fit of knee boots to wearers of varying sizes, including those whose calves are larger than average. The boots herein are comfortable without further modification by wearers, who do not have to cut or compromise the height or liquid protection of the boot to accommodate their calves. Gusseted boots allow for improved fit over a range of calf sizes, while also providing added comfort while walking since the muscles in the calves will expand and move within the boot.

Reference herein to “knee boot” refers to footwear designed to protect feet and lower legs, with a top of the boot extending nominally towards a wearer's knee. That is, a boot that is a knee boot covers all or a portion of a wearer's calf and may extend to the wearer's knee or just below it.

Reference to “integral” means that in forming the upper of the boot, the gusset and the upper body form a unitary structure. In one or more non-limiting embodiments, a mold is designed to include both the gusset feature and the upper body, in which case, a single injection of a polymeric material yields an upper comprising an upper body and a gusset integral to the upper body.

Reference to “affix” or “affixed” means that a pre-fabricated item connects to another item by way of gluing (e.g., adhesive or epoxy or other glue) or by direct attachment injection molding techniques. In one or more other non-limiting embodiments, a gusset may be injection molded in a gusset mold, the gusset is then placed in a boot upper mold and the upper body is injected around the pre-fabricated gusset by direct attachment injection techniques. The gusset is thereby affixed to the upper body. A pre-fabricated polymeric gusset may be glued to a pre-fabricated polymeric upper body to affix the gusset to the upper body. If a gusset is pre-fabricated, it may be of the same or different but compatible polymer of the upper body. Likewise, an outsole may be pre-fabricated by injection molding, which is then placed in a boot upper mold and the upper body is injected to the pre-fabricated outsole by direct attachment injection techniques. The outsole is thereby affixed to the upper body. The outsole may alternatively be affixed by adhesive or epoxy or other glue.

A “gusset” is a structural feature designed to allow expansion of a desired article such as a boot. Gussets as disclosed herein are polymeric and generally self-supporting. A gusset is expandable and is dimensioned along an article to impart expansion to a desired location. Overall geometry of a gusset may vary in width and height depending on the application. Upon application of a force, a gusset moves from a relaxed or resting or original (unexpanded) position to an expanded position. Gussets may comprise any desired geometry that is amenable to a boot's design. That is, a gusset may be generally triangular, trapezoidal, rhomboidal, and the like, so long as it can possess both unexpanded and expanded positions. In an embodiment, a gusset may comprise one or more pleats.

A “pleat” is a fold and material on either side of the fold, upon application of a force, a pleat can move from a relaxed or resting or original position to an expanded or unfolded position. A plurality of pleats can form an accordion fold construction. Dimensions and number of pleats for a gusset may vary with application.

A “cleat” is a feature of an outsole, which is integral to a body of the outsole protruding from a surface of the outsole for traction purposes. An array of cleats constitutes a tread pattern. The cleats and overall tread pattern afford the wearer slip resistance over a wide range of surfaces.

Before describing several exemplary embodiments of the invention, it is to be understood that the invention is not limited to the details of construction or process steps set forth in the following description. The invention is capable of other embodiments and of being practiced or being carried out in various ways.

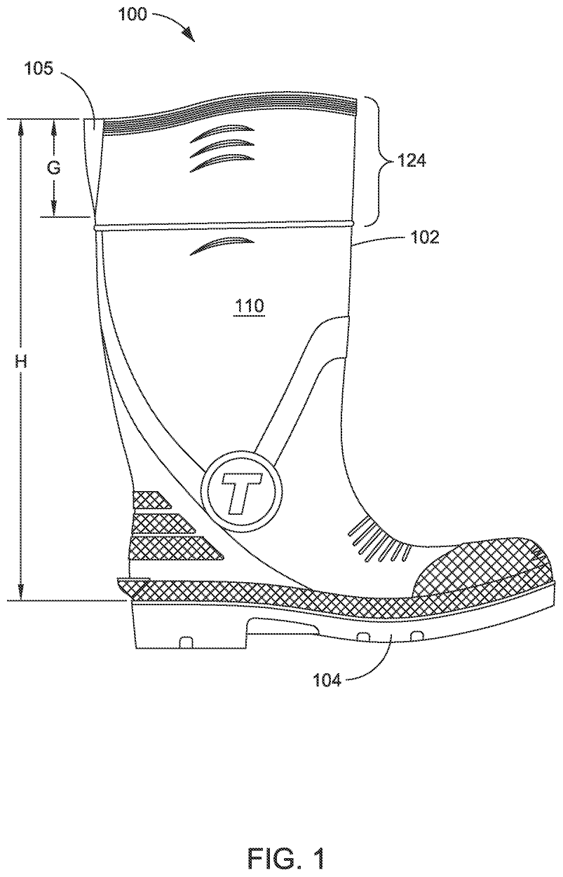

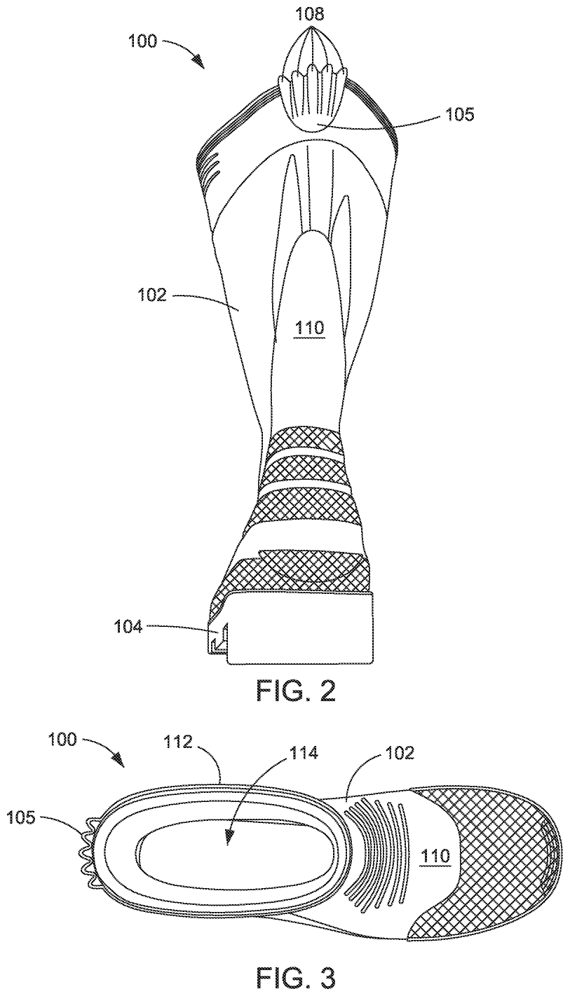

Turning to the figures, FIG. 1 is a schematic side view of a boot 100, and FIG. 2 is a schematic rear view of the boot 100. With reference to both figures, the boot 100 comprises an upper 102 and an outsole 104. The upper 102 is affixed to the outsole 104 and is designed for providing a knee boot in that, without being limited by an exact length or location on a wearer, the boot extends to the general area to or at or below a wearer's knee. The upper 102 has a height “H” as denoted in FIG. 1. The outsole 104 can be any suitable material for providing foot protection and traction. The upper 102 is a polymeric material having an upper body 110 and a gusset 105. In a non-limiting embodiment, gusset 105 comprises a plurality of pleats 108, specifically 5 pleats. The boots according to this disclosure do not have a fastener associated with the gusset because the gusset herein is self-supporting and expands only as-needed. A fastener is not needed to close or otherwise manipulate the gusset. The gusset 105 extends along a rear side of the boot to a desired distance, denoted as “G” in FIG. 1, thereby providing general calf relief in a top area of the boot 124. Prior to the present invention, some wearers would remove the top area 124 in order to accommodate larger than average calves. Here, gusset 105 is dimensioned to provide calf relief without a wearer needing to modify the boot, which in turn does not compromise height of the boot or liquid protection. In one or more embodiments, the distance “G” that the gusset extends is 50% or less of “H”, 0.4*H, or 0.3*H, or even 0.25*H.

In FIG. 3, which is a schematic top view of the boot 100, upper 102 comprises upper body 110 and gusset 105. An edge 112 of the upper body 110 defines a topline opening 114. The topline opening 114 is generally larger at the top of the boot and tapers necks down towards an ankle area. For donning, the wearer's foot fits down and through the opening and into a throat of the boot. Gusset 105 intersects the edge 112.

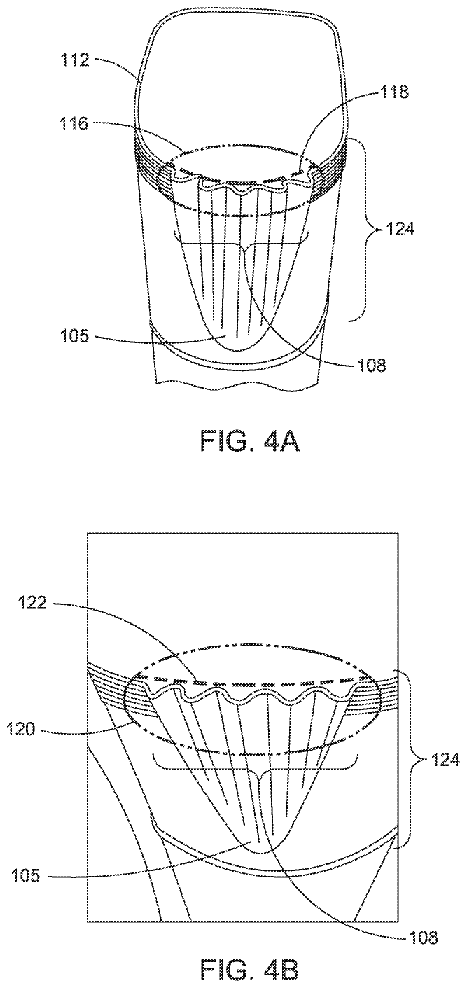

FIGS. 4A and 4B provide close-up schematic views of the gusset 105, comprising pleats 108, which intersects the edge 112. The gusset 105 is effective to expand the topline opening upon accommodating a leg of a wearer. The additional opening is dependent on the width or size of the gusset, the size and geometry of the pleats and the number of pleats. The edge or topline opening may expand at least an inch or even 1.5 inches depending on the boot size. In one or more embodiments, the circumference of the edge may increase from about 3 to about 10%, preferably in a range of 4-6%. In FIG. 4A, the gusset 105 comprises an original or resting or relaxed position 116 where the gusset is in a relaxed state, not expanded, and not receiving any force of expansion. Before the boot is donned, the gusset is in the relaxed, unexpanded state. The gusset 105 in its original contributes a base distance around the circumference of the edge 112. The base distance may be measured by a smooth line or arc 118 that connects one side of the gusset to the other. In FIG. 4B, the gusset 105 comprises an expanded position 120 to accommodate a wearer's leg upon donning of the boot. The gusset 105 in its expanded position contributes an expanded distance around the circumference of the edge 112. The expanded distance may be measured by a smooth line or arc 122 that connects one side of the gusset to the other. The expanded distance is always greater than the base distance. The gusset 105 extends from the edge 112 along a rear side of the boot to a desired distance, thereby providing general calf relief in the top area of the boot 124.

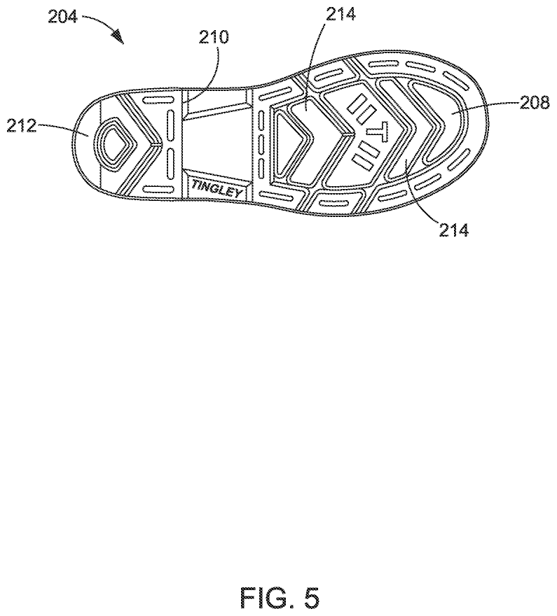

FIG. 5 provides a schematic bottom view of an exemplary outsole 204. For liquid protection purposes, outsole 204 is a first polymeric material that is injection-molded in a mold prepared according to desired design features. One or more integrally-formed design features of the outsole include but are not limited to: a toe 208, a heel 210, a heel strike 212, and one or more cleats 214. The cleats are generally in contact with the ground surface during use.

Generally, the outsole 204 comprises a polymeric material that is suitable for a variety of ground surfaces and surface conditions. A preferred polymeric material for the outsole is a thermoplastic elastomer, including but not limited to rubber, thermoplastic polyurethane and polyvinyl chloride. The outsole 204 is formed by injection molding the polymeric material into a mold cavity of a desired tread pattern.

The upper in accordance with this disclosure is liquid- and/or waterproof. Materials for the upper include but are not limited to polymeric materials. In one or more embodiments, the polymeric material of the upper is polyvinyl chloride. The upper may contain additional features as desired, such heel kicks, bands, grips, inner texture, and the like to facilitate donning and removing the boot.

The outsole generally comprises a polymeric material that may be the same or that may be different from the polymeric material of the upper depending upon the desired functionality of the footwear, but which is compatible to facilitate attachment of the outsole to the upper. In one or more embodiments, an outsole is formed by injecting a first polymeric material into a first mold cavity. An upper is formed by combining an upper body and a gusset. The gusset is made by injection molding a second polymeric material. The upper body is formed by injecting a third polymeric material into a second mold cavity. The outsole and upper may be made in any order. The upper is affixed to the outsole. In a specific embodiment, to affix the upper to the outsole, the upper is injection molded in direct contact with a pre-fabricated injection molded outsole. For making the upper, the second mold cavity may comprise one or more surfaces for forming the gusset integrally with the upper body, wherein the second and third polymeric materials are the same. Or for making the upper, the gusset may be pre-fabricated in a third mold cavity separate from the second mold cavity. Forming the upper may comprise injecting the second polymeric material of the upper body around the gusset that is held in the second mold cavity, or it may comprise affixing the pre-fabricated gusset to the upper body.

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in various embodiments,” “in one embodiment” or “in an embodiment” in various places throughout this specification are not necessarily referring to the same embodiment of the disclosure. Furthermore, the particular features, structures, materials, or characteristics may be combined in any suitable manner in one or more embodiments.

Although the disclosure herein provided a description with reference to particular embodiments, it is to be understood that these embodiments are merely illustrative of the principles and applications of the disclosure. It will be apparent to those skilled in the art that various modifications and variations can be made to the present disclosure without departing from the spirit and scope thereof. Thus, it is intended that the present disclosure include modifications and variations that are within the scope of the appended claims and their equivalents.

What is claimed is:

1. A method of making a boot comprising:
forming an outsole by injecting a first polymeric material into a first mold cavity;
forming a gusset by injection molding a second polymeric material;
forming an upper body by injecting a third polymeric material into a second mold cavity;
forming an upper comprising the gusset and the upper body; and
affixing the upper to the outsole.

2. The method of claim 1, wherein the outsole comprises one or more integrally-formed features selected from the group consisting of: a toe, a heel, a heel strike, and cleats.

3. The method of claim 1, wherein the first polymeric material is selected from the group consisting of rubber, thermoplastic polyurethane, and polyvinyl chloride.

4. The method of claim 1, wherein the second mold cavity comprises one or more surfaces for forming the gusset integrally with the upper body to form the upper, and the second and third polymeric materials are the same.

5. The method of claim 4, wherein the second and third polymeric materials are selected from the group consisting of rubber, thermoplastic polyurethane, and polyvinyl chloride.

6. The method of claim 5, wherein the second and third polymeric materials comprise polyvinyl chloride.

7. The method of claim 1, wherein the gusset is pre-fabricated in a third mold cavity separate from the second mold cavity, wherein forming the upper comprises injecting the second polymeric material of the upper body around the gusset that is held in the second mold cavity.

8. The method of claim 1, wherein the gusset is pre-fabricated in a third mold cavity separate from the second mold cavity, wherein forming the upper comprises gluing the gusset to the upper body.

9. The method of claim 1, wherein the gusset comprises one or more pleats.

10. The method of claim 1, wherein the gusset is self-supporting.

11. The method of claim 1, wherein the gusset is effective to expand a top area of the boot.

12. The method of claim 1, wherein the gusset in an expanded position upon accommodating a wearer's leg expands an edge of the upper body at least one inch.

13. A method of making a boot comprising:
forming an outsole by injecting a first polymeric material selected from the group consisting of rubber, thermoplastic polyurethane, and polyvinyl chloride into a first mold cavity;
forming a gusset by injection molding a second polymeric material comprising polyvinyl chloride;
forming an upper body by injecting a third polymeric material comprising polyvinyl chloride into a second mold cavity;
forming an upper comprising the gusset and the upper body; and
affixing the upper to the outsole by gluing or by direct attachment injection molding techniques.

14. The method of claim 13, wherein the outsole comprises one or more integrally-formed features selected from the group consisting of: a toe, a heel, a heel strike, and cleats.

15. The method of claim 13, wherein the gusset is pre-fabricated in a third mold cavity separate from the second mold cavity, wherein forming the upper comprises injecting the second polymeric material of the upper body around the gusset that is held in the second mold cavity.

16. The method of claim 13, wherein the gusset is pre-fabricated in a third mold cavity separate from the second mold cavity, wherein forming the upper comprises gluing the gusset to the upper body.

17. The method of claim 13, wherein the gusset comprises one or more pleats.

18. The method of claim 13, wherein the gusset is self-supporting.

19. The method of claim 13, wherein the gusset is effective to expand a top area of the boot.

20. The method of claim 13, wherein the gusset in an expanded position upon accommodating a wearer's leg expands an edge of the upper body at least one inch.
